(19) United States
(12) Patent Application Publication
(10) Pub. No.: US 2005/0114899 A1
(43) Pub. Date: May 26, 2005

(54) Digital set-top box

(76) Inventors: Victor Shih, Chung Ho City (TW); I-Te Chou, Chung Ho City (TW); Lieng-Min Fang, Chung Ho City (TW); Yan-Hua Liao, Chung Ho City (TW); Yang-Long Lin, Chung Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/714,798

(22) Filed: Nov. 17, 2003

(30) Foreign Application Priority Data
Oct. 27, 2003 (TW) 92129811

(51) Int. Cl. H04N 7/173; H04N 7/16; H04N 5/44; H04N 7/20; H04N 5/50

(52) U.S. Cl. 725/100; 725/131; 725/151; 725/139; 725/73; 348/725; 348/731

(57) ABSTRACT

A digital set-top box is disclosed. The digital set-top box comprises a tuner, a demultiplexer, a MPEG-2 decoder, a deinterlace video processor and a microprocessor. The digital set-top box further comprises a digital to analog converter. The digital set-top box can transfer the received digital broadcasting signal to a display signal compatible with the format to be received by a display, such as VGA or DVI signals, and a user can watch the display signal on the display.

### BACKGROUND

1. Field of Invention

The present invention relates to a digital set-top box. More particularly, the present invention relates to a digital set-top box that can output a display signal compatible with the format to be received by a display.

2. Description of Related Art

Recently, owing to the rapid prevalence of liquid crystal displays and liquid crystal televisions, the technology for converting a television signal into a liquid crystal display signal is also developing quickly. Up to now, there are three main digital television standards in the world, include Digital Video Broadcasting (DVB) created by European Broadcast Union (EBU), Advanced Television Systems Committee (ATSC) created by America and Integrated Services Digital Broadcasting (ISDB) created by Japan.

Now, there are two kinds of set-top boxes in the market, one is an analog set-top box and the other is a digital set-top box. It is important that only the analog set-top box (or referred to as a TV BOX) can output a VGA signal while the digital set-top box cannot output the VGA signal. That is, the digital set-top box is provided with CVBS and SCART outputs without a VGA output; therefore, the digital set-top box known in the art only can be used on a liquid crystal display television (LCD TV). Therefore, according to the digital set-top box in the present market, which cannot display a video signal on a personal computer monitor.

### SUMMARY

It is therefore an objective of the present invention to provide a digital set-top box that can transfer the received digital broadcasting signal to a display signal compatible with the format to be received by the display.

In accordance with the foregoing and other objectives of the present invention, a digital set-top box is provided. The digital set-top box comprises a tuner, a demultiplexer, a MPEG-2 decoder, a deinterlace video processor and a microprocessor. The tuner receives a digital broadcasting signal to generate a digital data stream. The demultiplexer receives the digital data stream to generate a digital video signal. The MPEG-2 decoder receives the digital video signal to generate an interlaced digital video signal. The deinterlace video processor receives the interlaced digital video signal to generate a digital RGB signal, wherein the digital video signal can be transmitted to a display via a DVI interface for a user to be watched on the display. And, the microprocessor is connected to the tuner, the demultiplexer, the MPEG-2 decoder and the deinterlace video processor, for transmitting related data signal to each unit and controlling an operation of each unit.

The digital set-top box of the invention further comprises a digital to analog converter for receiving the digital RGB signal and converting the digital RGB signal into an analog RGB signal, wherein the analog RGB signal can be transmitted to a display via a VGA interface for a user to be watched on the display.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating the digital set-top box of the invention.

### DESCRIPTION OF THE PREFERRED EMBODIMENTS

Reference will now be made in detail to the present preferred embodiments of the invention, examples of which are illustrated in the accompanying drawings.

The operation of the digital set-top box 100 of the invention is given in the following description. The digital set-top box 100 is used for receiving a digital broadcasting signal and converting the digital broadcasting signal into a display signal compatible with the format to be received by a personal computer display. Disclosed herein is the operation of a video signal of the digital broadcasting signal, and the operation of an audio signal of the digital broadcasting signal is performed in a conventional manner, thus the operation of the audio signal of the digital broadcasting signal will not be described in below.

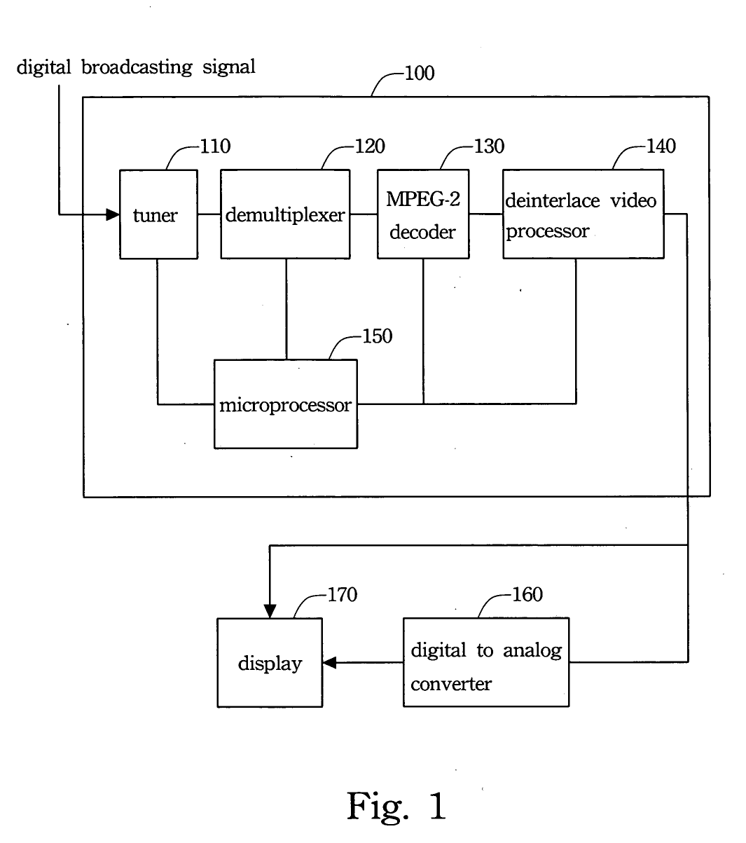

Referring to FIG. 1, FIG. 1 is a block diagram illustrating the digital set-top box of the invention. The digital set-top box 100 includes a tuner 110, a demultiplexer 120, a MPEG-2 decoder 130, a deinterlace video processor 140 and a microprocessor 150. The microprocessor 150 is connected to the tuner 110, the demultiplexer 120, the MPEG-2 decoder 130 and the deinterlace video processor 140. The microprocessor 150 is used to transmit related data signals to each unit and control operation of each unit.

The operation of the digital set-top box 100 of the invention is described as follows.

The tuner 110 receives a digital broadcasting signal to generate a digital data stream and transmits the digital data stream to the demultiplexer 120. The digital broadcasting signal described above includes a digital cable broadcasting signal or a digital wireless broadcasting signal. The digital cable broadcasting signal includes, for example, DVB-C or ISDB-C. The digital wireless broadcasting signal includes, for example, a digital wireless terrestrial broadcasting signal such as DVB-T or ISDB-T, a digital wire satellite broadcasting signal such as DVB-S or ISDB-S, and ATSC.

Then, the demultiplexer 120 generates a digital video signal according to the received digital data stream. Next, the MPEG-2 decoder 130 generates an interlaced digital video signal according to the digital video signal. Next, the deinterlace video processor 140 receives the interlaced digital video signal from the MPEG-2 decoder 130 to generate a digital RGB signal.

If the display 170 is provided with a Digital Visual Interface (DVI) port, the deinterlace video processor 140 can directly transmit the digital RGB signal via the DVI port to the display 170 for a user to be watched on the display 170. On the other hand, if the display 170 is provided without a DVI port, the deinterlace video processor 140 transmits the digital RGB signal to a digital to analog converter 160, and the digital to analog converter 160 converts the digital RGB signal into an analog RGB signal and transmits the analog RGB signal via a VGA interface to the display 170 for the user to be watched on the display 170. The display 170 includes a CRT monitor or a LCD.

As described above, the digital set-top box of the invention can transfer the received digital cable broadcasting signal or the received digital wireless broadcasting signal to a display signal compatible with the format to be received by a display, such as VGA or DVI signals, and a user can watch the display signal on the display.

Although the present invention has been described in considerable detail with reference to certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A digital set-top box, comprising:
a tuner for receiving a digital broadcasting signal and generating a digital data stream;
a demultiplexer for receiving said digital data stream and generating a digital video signal;
a MPEG-2 decoder for receiving said digital video signal and generating an interlaced digital video signal;
a deinterlace video processor for receiving said interlaced digital video signal and generating a digital RGB signal, wherein said digital video signal can be transmitted to a display via a DVI interface for a user to be watched on said display; and
a microprocessor connected to said tuner, said demultiplexer, said MPEG-2 decoder and said deinterlace video processor, for transmitting related data signal to each unit and controlling an operation of each unit.

2. The digital set-top box of claim 1, further comprising a digital to analog converter for receiving said digital RGB signal and converting said digital RGB signal into an analog RGB signal, wherein said analog RGB signal can be transmitted to said display via a VGA interface for a user to be watched on said display.

3. The digital set-top box of claim 1, wherein said digital broadcasting signal comprises a digital cable broadcasting signal.

4. The digital set-top box of claim 1, wherein said digital broadcasting signal comprises a digital wireless broadcasting signal.

5. The digital set-top box of claim 4, wherein said digital wireless broadcasting signal comprises a digital wireless terrestrial broadcasting signal.

6. The digital set-top box of claim 5, wherein said digital wireless terrestrial broadcasting signal comprises a DVB-T terrestrial broadcasting signal.

7. The digital set-top box of claim 4, wherein said digital wireless broadcasting signal comprises a digital wireless satellite broadcasting signal.

8. The digital set-top box of claim 7, wherein said digital wireless satellite broadcasting signal comprises a DVB-S satellite broadcasting signal.

9. The digital set-top box of claim 4, wherein said digital wireless broadcasting signal comprises an ATSC digital broadcasting signal.
